(19) United States
(12) Patent Application Publication
(10) Pub. No.: US 2026/0269320 A1
(43) Pub. Date: Sep. 10, 2026

(54) SALT MIXTURE FOR LITHIUM BATTERIES AND USE THEREOF

(71) Applicants: Tao Li, Naperville, IL (US); Lingzhe Fang, DeKalb, IL (US); Yuan Zhang, DeKalb, IL (US)

(72) Inventors: Tao Li, Naperville, IL (US); Lingzhe Fang, DeKalb, IL (US); Yuan Zhang, DeKalb, IL (US)

(73) Assignee: Board of Trustees of Northern Illinois Univeristy, DeKalb, IL (US)

(21) Appl. No.: 19/073,914

(22) Filed: Mar. 7, 2025

(51) Int. Cl. H01M 10/0568; H01M 4/525; H01M 10/0525; H01M 10/0569

(52) U.S. Cl. CPC H01M 10/0568; H01M 4/525; H01M 10/0525; H01M 10/0569; H01M 2300/0034; H01M 2300/004

(57) ABSTRACT

A composition for preparing a lithium battery electrolyte comprises lithium bis(pentafluoroethanesulfonyl)imide (LiBETI) and lithium hexafluorophosphate (LiPF₆).

A lithium battery comprises an anode comprising lithium, a cathode comprising nickel, and an electrolyte. The electrolyte contains lithium bis(pentafluoroethanesulfonyl)imide (LiBETI), lithium hexafluorophosphate (LiPF₆), and an organic solvent.

### GOVERNMENT RIGHTS

This invention was made with the following U.S. Government support: grant number G2A24445 funded by the Department of Energy (DOE). The U.S. Government has certain rights in this invention.

### BACKGROUND

In the past thirty years, lithium-ion batteries (LIBs) have played an increasingly important role in energy storage applications, for example in electric vehicles (EVs) and mobile electronic devices. However, the demand for LIBs with high energy density and long cycle life has not been met. The cathode plays a dominating role in the performance of LIBs. Among commercialized cathode materials, Ni-rich layered oxide cathodes (Ni≥0.6), LiNi_{0.8}Co_{0.1}Mn_{0.1}O₂ (NCM811, or “NCM”) exhibits a higher practical specific capacity over 200 mAh g⁻¹ and an energy density up to 800 Wh kg⁻¹, as compared to LiCoO₂ (~145 mAh g⁻¹) and LiFePO₄ (~170 mAh g⁻¹). The high Ni content enables NCM to have a larger specific capacity and high operation voltage with lower cost and toxicity. As a major redox participant, Ni ions offer the most capacity through the Ni²⁺/Ni³⁺ and Ni³⁺/Ni⁴⁺ redox couples. The presence of Co suppresses Ni/Li cationic mixing to a certain degree and increases the ionic conductivity of NCM. Mn ions do not participate in redox reactions but maintain structural stability by remaining at a +4 valence. However, the degradation of long-term cycling stability in NCM, especially when operated at high charge cut-off voltages (>4.3 V Li⁺/Li) to achieve higher energy density, undermines its strength. There are several factors that lead to the rapid performance degradation of this cathode material during repeated cycles.

The lithium salts containing fluorine, such as the commonly used LiPF₆, are sensitive to residue water in the electrolyte or on the NCM particle surface. The formation of HF is derived from the hydrolysis of LiPF₆, which induces the corrosion of NCM particles and results in the significant dissolution of transition metal ions into the electrolyte. The transition metal dissolution leads to damage to the layered structure and a loss of active material. More seriously, the dissolved transition metal ions diffuse to the anode side of the battery and inhomogeneous deposit on the anode surface via electrochemical reduction, blocking the Li⁺ ions diffusion paths. The transition metal dissolution is more severe at charge potentials above 4.5 V vs. Li/Li⁺ and is considered as the main reason for capacity and working voltage degradation. These challenges are more serious in Ni-rich NCM811 under harsh operation conditions, such as the high charge cutoff voltages (>4.5 V vs. Li/Li⁺) used to achieve desirable energy densities. These challenges are strongly related to the interfacial properties and electrolyte compositions.

Electrolytes play essential roles, not only in lithium ion transport but also in cathode electrolyte interphase (CEI) formation. Solvent decomposition dominates the CEI formation in traditional dilute electrolytes (~1 M) as the Li⁺ solvation sheath is dominated by polar solvents. To mitigate the solvent parasitic reactions on electrode surfaces, anion-dominant interfacial processes have been explored to modify the solid-liquid interphase properties. By developing high-concentration electrolytes (HCEs), anion-enriched solvation sheaths lead to anion-dominant reactions at the electrode surface. The typical CEI is primarily derived from solvents and consists predominantly of organic compounds, along with some inorganic compounds. This incompact and unsolidified mosaic-type CEI does not support long-cycling and high-voltage NCM811. In contrast, the inorganic-rich CEI (LiF, Li₂O, etc.) is derived from inorganic lithium compounds in HCEs. The compact and uniform CEI rich in inorganic components enhances lithium ion transport and suppress deleterious cathode-electrolyte side reactions, thereby enabling reversible electrochemical processes. Therefore, modifying lithium salts holds great potential for achieving long cycling performance in high-voltage NCM811 cathodes using concentrated electrolytes.

### SUMMARY

In a first aspect, the invention includes a composition for preparing a lithium battery electrolyte, comprising lithium bis(pentafluoroethanesulfonyl)imide (LiBETI) and lithium hexafluorophosphate (LiPF₆).

In a second aspect, the invention includes an electrolyte for a lithium battery, comprising lithium bis(pentafluoroethanesulfonyl)imide (LiBETI), lithium hexafluorophosphate (LiPF₆), and and an organic solvent.

In a third aspect, the invention includes a lithium battery, comprising an anode comprising lithium, a cathode comprising nickel, and an electrolyte. The electrolyte contains lithium bis(pentafluoroethanesulfonyl)imide (LiBETI), lithium hexafluorophosphate (LiPF₆), and an organic solvent.

All amounts are by weight, unless otherwise stated.

### BRIEF DESCRIPTION OF THE DRAWINGS

FIG. 1A is a graph of conductivity of different electrolytes.

FIG. 1B is a graph of viscosity of different electrolytes.

FIG. 2A illustrates Raman spectra of electrolytes and their corresponding salt and solvents.

FIG. 2B illustrates FTIR spectra of electrolytes and their corresponding salt and solvents.

FIG. 2C illustrates SAXS data of electrolytes and their corresponding salts and solvent.

FIG. 3A and FIG. 3B are graphs showing ⁷Li and ¹⁹F chemical shifts of different lithium salts, respectively.

FIG. 4A, FIG. 4B, FIG. 4C and FIG. 4D are graphs showing a comparison of cycling stabilities of NCM811/Li half cells in different electrolytes at 1 C rate and 4.6 V charge cutoff voltage.

FIG. 5 is rate performance of NCM811/Li half cells in three kinds of electrolyte from 0.1 C to 5 C with 4.6 V charge cutoff voltage.

FIG. 6A, FIG. 6B and FIG. 6C are scanning electron microscope (SEM) images of the thickness and morphology plated lithium on Cu foil, prepare in electrolytes containing 1 m LiPF₆, 2 m LiBETI and the basalt, respectively.

FIG. 7A, FIG. 7B, FIG. 7C, FIG. 7D, and FIG. 7E are X-ray photoelectron spectra (XPS) of NCM811 cathodes after different cycles, for carbon 1s, oxygen 1s, phosphorus 2p, fluorine 1s, and nickel 2p (with the legend for all the spectra only in FIG. 7E), respectively.

FIG. 7F, FIG. 7G, FIG. 7H, and FIG. 7I are X-ray photoelectron spectra (XPS) of NCM811 cathodes after 100 cycles, for carbon 1s, oxygen 1s, fluorine 1s, and phosphorus 2p, respectively.

FIG. 8A, FIG. 8B and FIG. 8C are scanning electron microscope (SEM) images of the morphology of lithium anodes after 100 cycles in NCM811/Li half cells.

FIG. 9A, FIG. 9B, and FIG. 9C are graphs showing depth profiles of Time-of-Flight Secondary Ion Mass Spectrometry (ToF-SIMS) of NCM811 cathodes after 100 cycles in 1 m LiPF₆, 2 m LiBETI and 2 m LiBETI+0.5m LiPF₆, respectively.

FIG. 10A, FIG. 10B and FIG. 10C are HR STEM images of NCM811 particles after 100 cycles in an operation voltage of 2.8-4.6 V: in 1 m LiPF₆, in 2 m LiBETI, in 2 m LiBETI+1m LiPF₆, respectively.

FIG. 11 shows a battery having a cathode, an anode, and a separator.

FIG. 12 illustrates a schematic of a lithium-ion battery.

### DETAILED DESCRIPTION

The present invention makes use of the discovery that high concentration electrolyte containing lithium bis(pentafluoroethanesulfonyl)imide (LiBETI) and lithium hexafluorophosphate (LiPF₆) in a mixture of organic solvents, provides for improved electrical properties in lithium batteries having a nickel containing cathode. The bisalt electrolyte in lithium batteries, leads to improved cycling life under high voltage. Compared with single salt electrolytes, the bisalt electrolyte can achieve a higher concentration by dissolving an additional lithium salt. Moreover, introducing a less expensive lithium salt into the bisalt electrolyte avoids the extensive use of expensive lithium salts in the high concentrated electrolyte, thereby reducing overall cost. Besides the physical properties changes, such as ionic conductivity, viscosity, and the wettability, the electrolyte solvation structure can also be changed in bisalt electrolyte systems. Therefore, the interfacial reactions between the electrolyte and cathode or lithium metal anode is also change. The CEI on the cathode helps to prevent transition metal dissolution and accommodates particle volume changes. The solid electrolyte interphase (SEI), a thin, inorganic layer that forms on the surface of a lithium battery, facilitates efficient lithium plating/deplating while suppressing lithium dendrite growth. The bisalts electrolyte provides opportunities to modulate the CEI/SEI inorganic compositions, thereby improving the properties of the SEI and the CEI.

The salts used for the electrolyte are LiBETI and LiPF₆. Preferably, the salts are used in a molar ratio of LiBETI to LiPF₆ of 6:1 to 1:3, more preferably 3:1 to 1:1, such as in a 2:1 molar ratio.

Preferably, the electrolyte contains a high concentration of salts. Preferably, the electrolyte contains a concentration of LiBETI of at least 0.5 m, more preferably at least 1 m, and most preferably at least 1.5 m, including 2 m, 2.5 m, 3 m and up to the solubility limit of the salt. Preferably, the electrolyte contains a concentration of LiPF₆ of at least 0.25 m, more preferably at least 0.5 m, and most preferably at least 0.75 m, including 1 m, 1.5 m, 2 m and up to the solubility limit of the salt.

The solvent for the electrolyte contains organic solvents, preferably a mixture fluoroethylene carbonate (FEC), ethylene carbonate (EC), and ethyl methyl carbonate (EMC), for example a mixture of these 3 solvents in volume ratio of 1:2:7, respectively. Other organic and fluorinated solvents may also be used.

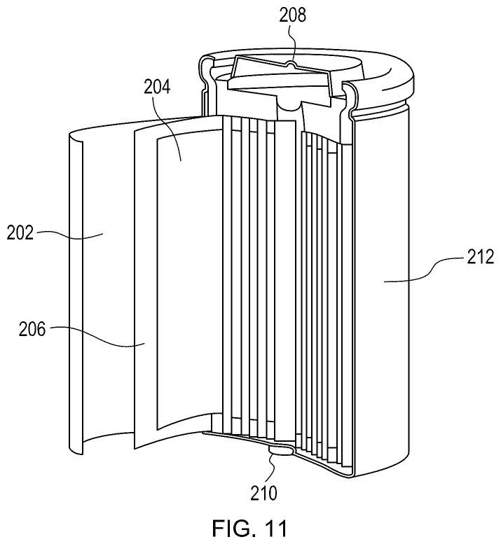

FIG. 11 illustrates a battery, 200. The battery has an anode, 202 and a cathode, 204. The anode and cathode are rolled up, and a separator, 206, is between the cathode and anode. The battery has a positive terminal, 208 and a negative terminal 210. The battery is enclosed in a housing, 212.

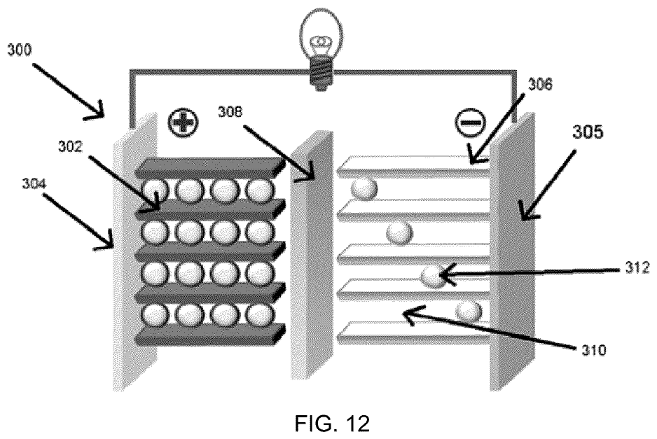

FIG. 12 illustrates a schematic of a battery, 300. The battery has a cathode, 302, illustrated as thin film strips, attached to a cathode charge collecting element, 304. The anode, 306 is attached to an anode charge collecting element, 305. A separator, 308 is positioned between the anode and cathode. The electrolyte, 310 is in contact with the anode and cathode, and allows for the movement of ions, 312 between the anode and cathode.

### EXAMPLES

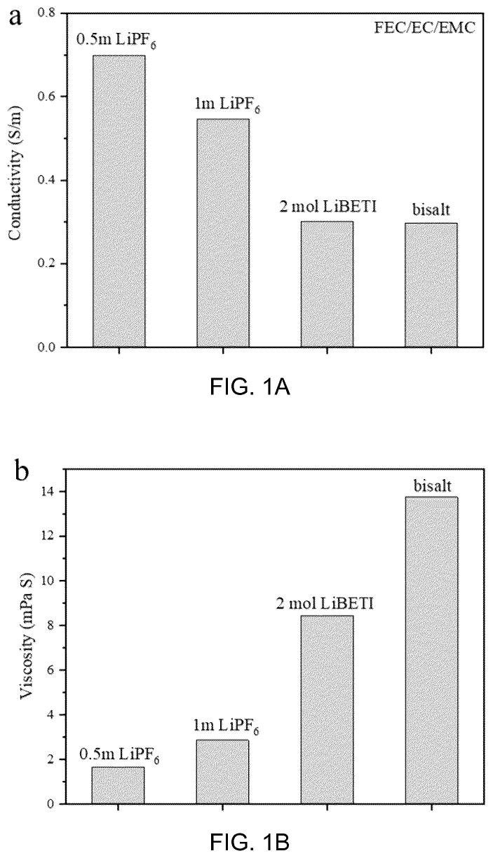

The bisalt electrolyte used included two lithium salts, lithium bis(pentafluoroethanesulfonyl)imide (LiBETI) and lithium hexafluorophosphate (LiPF₆). The organic solvent used was composed of fluoroethylene carbonate (FEC), ethylene carbonate (EC), and ethyl methyl carbonate (EMC) with a volume ratio of 1:2:7. For the preparation of specific concentration of 2 m LiBETI+1 m LiPF₆, 774.2 mg LiBETI and 75.95 mg LiPF₆ salts were weighted in a glove box. The salts were placed into a 5mL glass bottle and 1 g of organic solvent was added. Then, a magnetic stir bar was used to stir composition overnight to obtain a clear electrolyte without precipitates. The comparative electrolytes, 1 m LiPF₆ and 2 m LiBETI, were prepared in the same manner. As shown in FIG. 1A and FIG. 1B, the viscosity of the electrolyte is increased as the concentration increase. Because of the high concentration of the bisalt electrolyte, the conductivity is smaller than the 1 m LiPF₆ electrolyte, but comparable to 2 m LiBETI electrolyte.

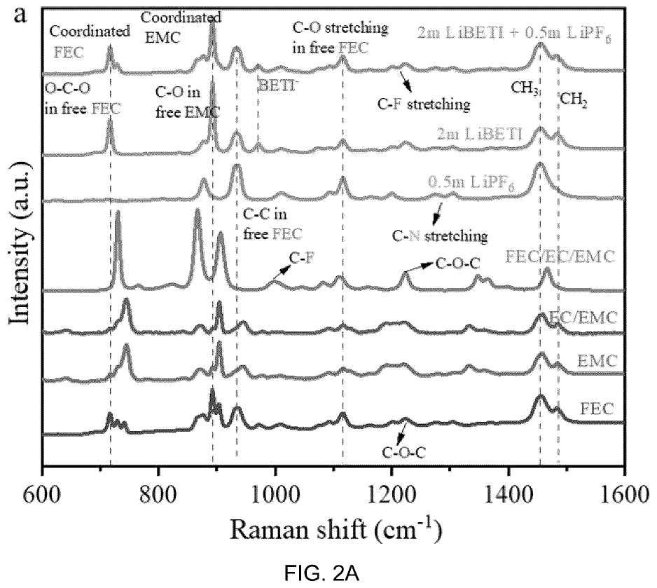

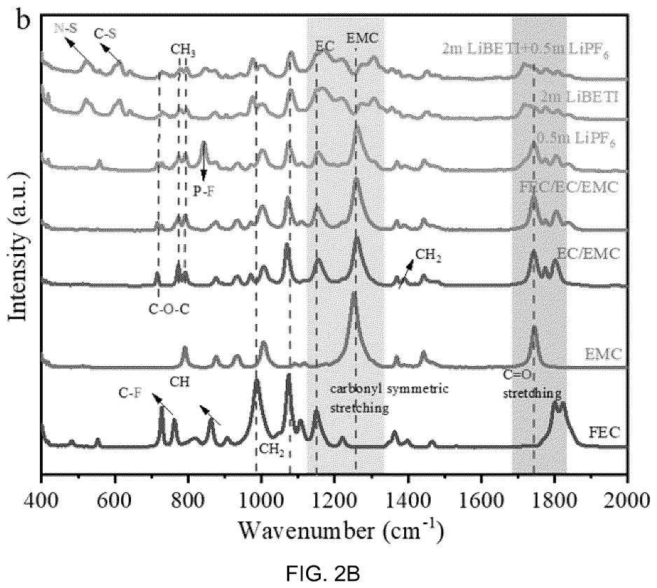

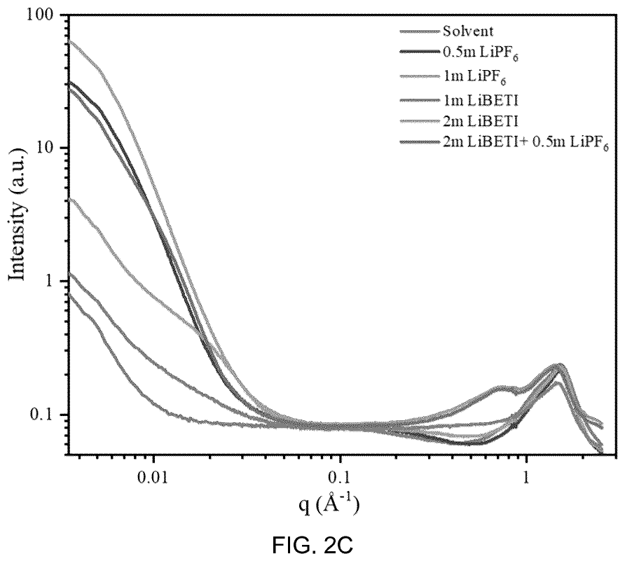

Raman spectroscopy can be used to capture the chemical bond stretching of solvent and salt molecules. FIG. 2A illustrates Raman spectra of electrolytes and their corresponding salt and solvents, while FIG. 2B illustrates the corresponding FTIR spectra. As shown in FIG. 2A, the peaks from the free solvent have been suppressed in bisalt electrolyte, which indicates that the solvent structure is changed from the solvent separated ion pairs to contact ion pairs in the primary solvation shell of lithium ion as the concentration of the electrolyte increased. Fourier transform infrared (FTIR) spectroscopy and Raman spectroscopy are both valuable methods for identifying species through vibrational excitation, though they are complementary in nature. Raman spectroscopy relies on the inelastic scattering of incident monochromatic light, while FTIR spectroscopy gathers molecular information through the absorption of specific wavelengths in polychromatic light. Compared to the FTIR spectra of 2 m LiBETI electrolyte, the bisalt electrolyte contains the P—F bond. Different from the local chemical bond vibration and stretching shown by Raman and FTIR spectra, small angle X-ray scattering (SAXS) shows the structure of electrolyte at nanometer scales. As shown in FIG. 2C, there is a bump peak in 2 m LiBETI and the bisalt electrolyte, indicating that aggregates are formed.

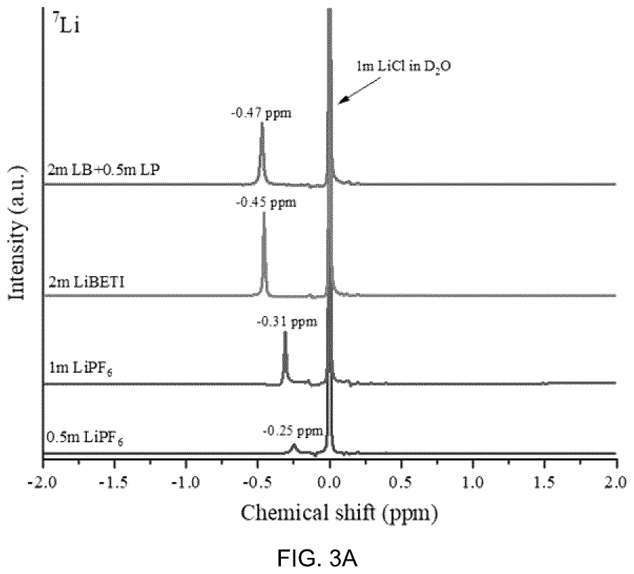

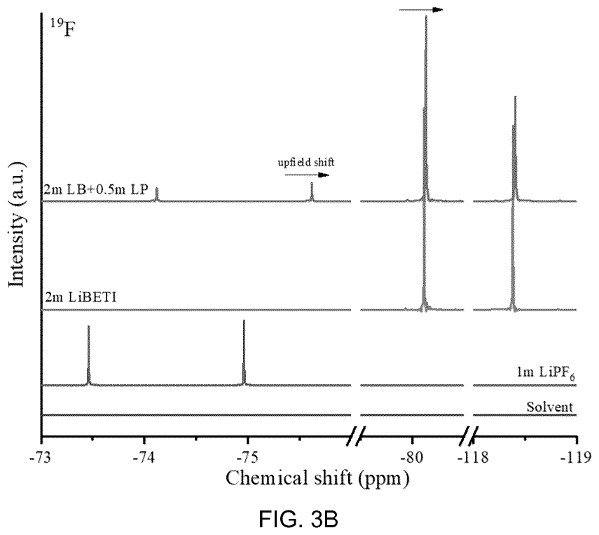

Nuclear magnetic resonance (NMR) is an important non-destructive analytical technique to study chemical structure. As shown in FIG. 3A and FIG. 3B, both ⁷Li and ¹⁹F NMR of the bisalt electrolyte shift to more negative values compared to the single salt electrolytes, which means a stronger solvation interaction with both solvent and anions.

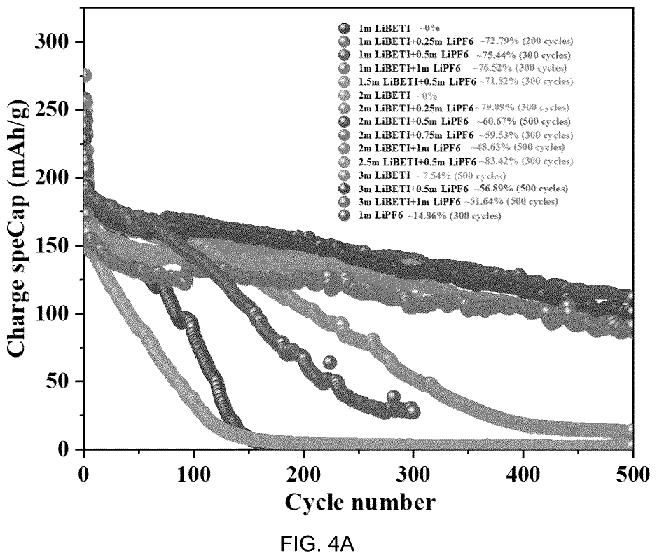

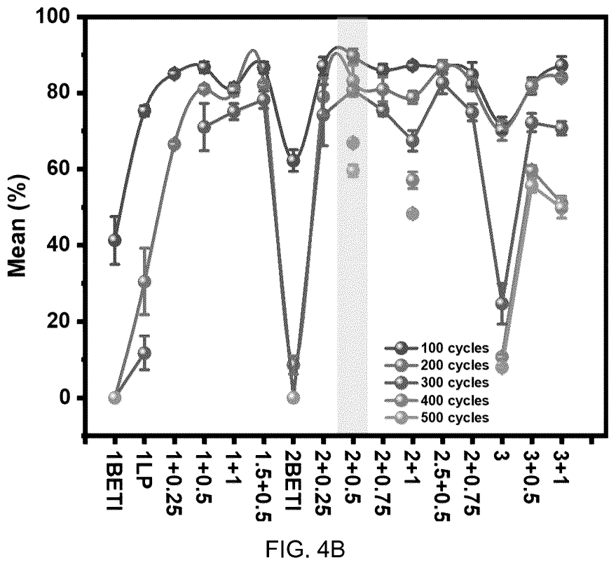

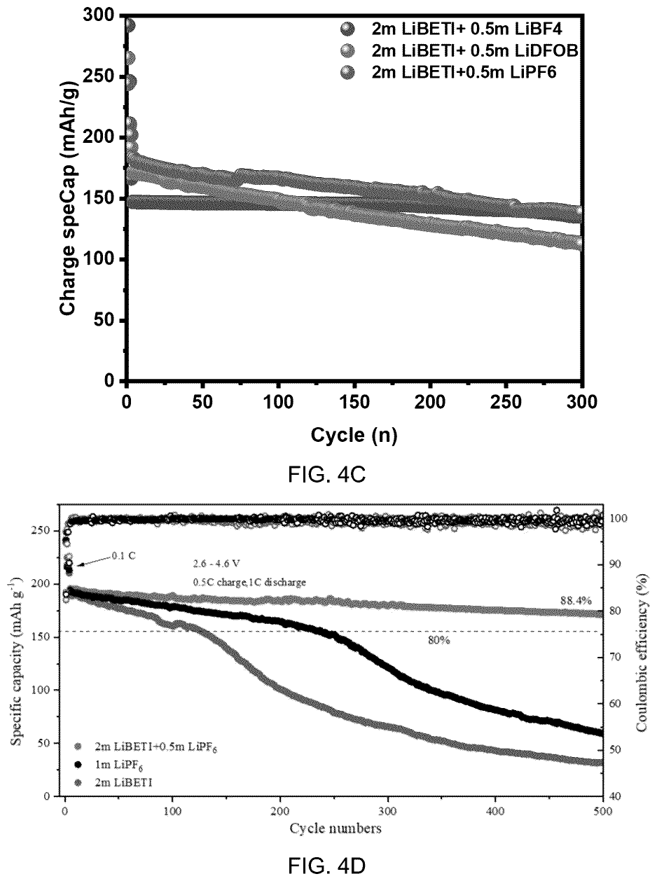

The electrochemical performance of NCM811/Li cells in different electrolytes with a 4.6 V charge cutoff voltage have been explored. FIG. 4A, and FIG. 4B are graphs showing a comparison of cycling stabilities of NCM811/Li half cells in different electrolytes at different ratios between LiPF₆ and LiBETI salts, while FIG. 3C is a graph showing the effect of different salt additives and FIG. 3D is a graph showing long term cycling performance of a NCM811/Li half-cell in the basalt, 1 m LiPF₆, and 2 m LiBETI electrolytes in a voltage of 2.8-4.6V at 1 C. As shown in FIG. 4A, FIG. 4B and FIG. 4D, when the charge cutoff voltage is 4.6V, the capacity retentions of the cells in 1 m LiPF₆, 32 m LiBETI, and 2 m LiBETI+1 m LiPF₆ after 500 cycles are 31.3%, 15.4%, and 88.4%, respectively. The bisalt electrolyte shows the best cycling stability compared to other ratios. In addition, after replacing LiPF₆ with LiBF₄ or lithium difluorooxalatoborate (LiDFOB), the cycle performance is worse. The significantly increased electrode cycling life under high voltage operation condition demonstrates the advantages of the bisalt electrolyte in adjusting solvation structure and electrode-electrolyte interface.

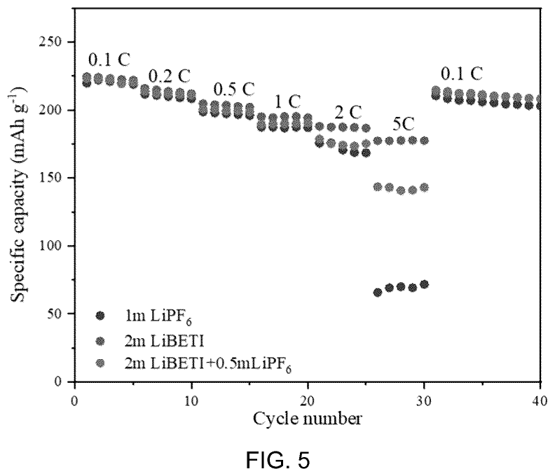

The rate performance of NCM811/Li half-cell is studied (FIG. 5). Compared to 1 m LiPF₆, the specific capacity retentions at 2 C and 5 C are larger in 2 m LiBETI and the bisalt electrolyte. Even though the high viscosity induced lower specific capacity at 5 C is observed in the bisalt electrolyte, the improved cell stability makes the bisalt electrolyte still a promising choice.

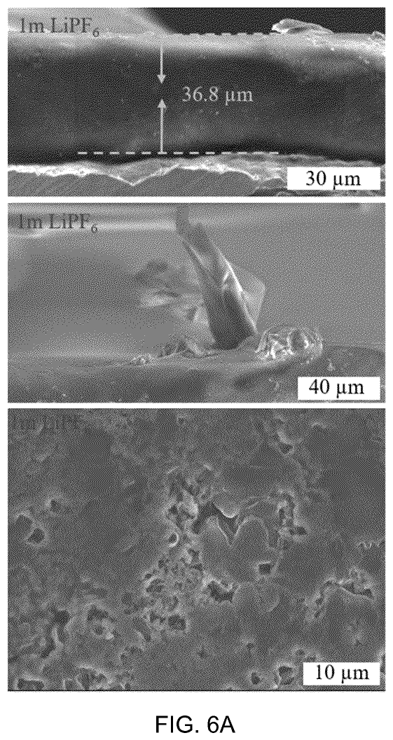

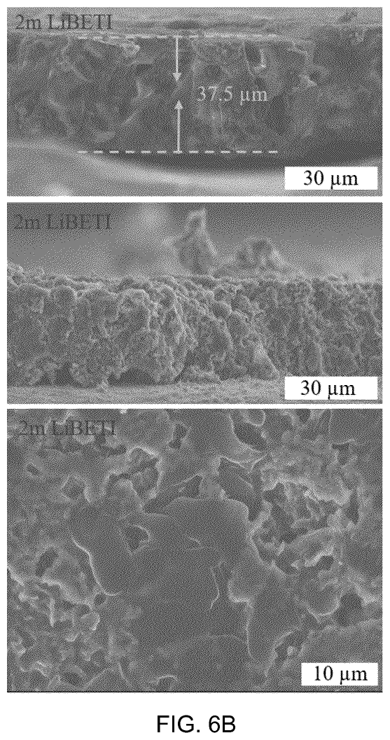

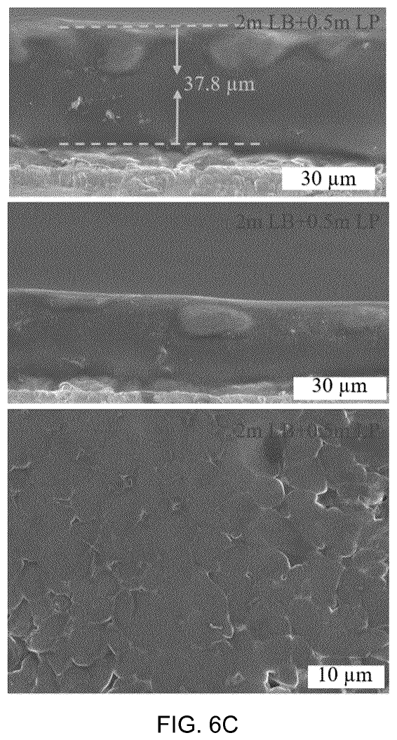

The characterization of thickness and morphology of Li metal on Cu foil is a good method to disclose the compatibility capability of electrolytes with Li metal. FIG. 6A, FIG. 6B and FIG. 6C, show SEM to measure the Li metal in a Li/Cu half-cell. The plating thickness is almost the same for the three electrolytes. However, the absence of lithium dendrites and dense lithium plating in the bisalt electrolyte shows the good interphase stability on lithium.

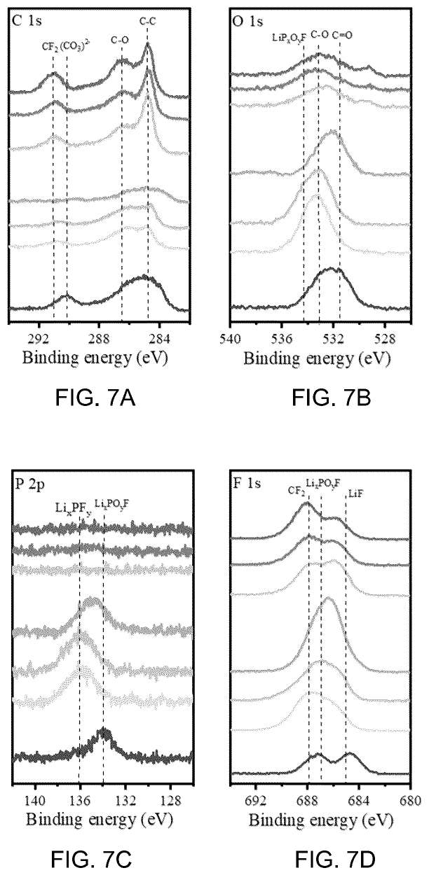

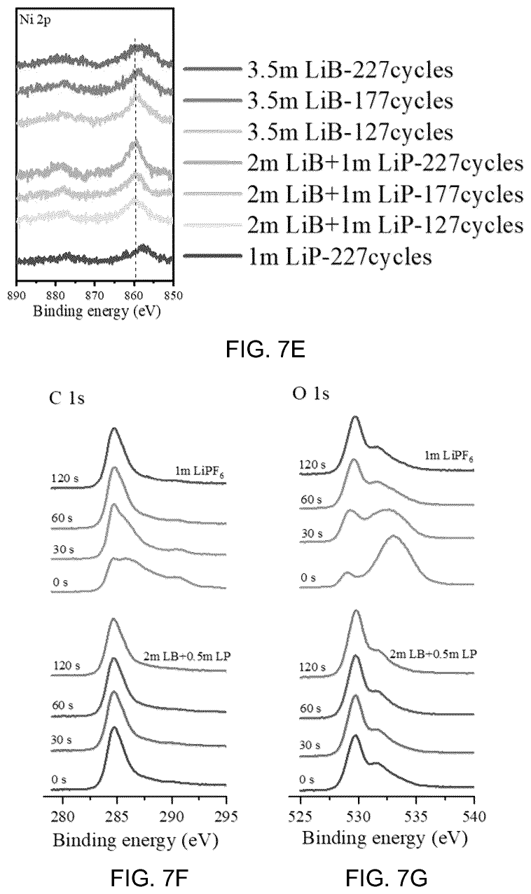

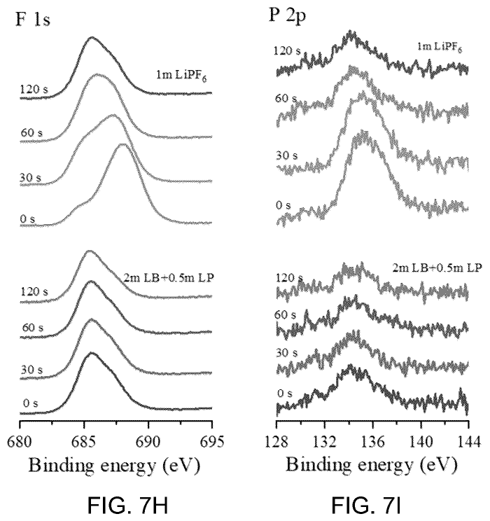

The compositions of CEIs in different electrolytes after cycles were characterized by X-ray photoelectron spectra (XPS) to reveal the surface chemistry effect on high voltage cycling stability. FIG. 7A, FIG. 7B, FIG. 7C, FIG. 7D and FIG. 7E are X-ray photoelectron spectra (XPS) of an NCM811 cathode after different cycles, for carbon 1 s, oxygen 1 s, phosphorus 2 p, fluorine 1 s, and nickel 2 p, respectively. As shown in these figures, four peaks can be observed in the C 1s spectrum. The peaks at 286.5 and 291 eV are assigned to the C−O, and C−F of the organic component, and the peak at 290 eV represents Li₂CO₃, respectively. The NCM811 cycled in 3.5 m LiBETI electrolyte shows strong C 1s signal (C−O, CF₂), indicating that the CEI derived from pure LiBETI electrolyte should consist of more organic components. In comparison, more Li₂CO₃ was identified after 227 cycles in 1 m LiPF₆ electrolyte. The NCM811 in the bisalt electrolyte has less C 1s intensity because of the signals of C═O, C—O in O 1s and LiPₓF_{y} in P 2p weakening the intensity of C—F and C—C bonds from the PVDF and conductive carbon. Moreover, the O 1s peak in the bisalt electrolyte shifts to lower binding energy side, which means more C═O. Additionally, the P 2p XPS spectra of NCM811 in the bisalt electrolyte indicates that the CEI layer contained significant amounts of LiPF₆ decomposition products such as LiₓPO_{y}F and LiₓPF_{y}. Significantly, the peak shifts to lower binding energy side as the NCM811 cycled from 177 cycles to 227 cycles, indicating more LiₓPO_{y}F specifies in CEI. Correspondingly, different from the dominated CF₂ signal in 3.5 m LiBETI electrolyte in F 1s spectra, LixPOyF occupies the majority in bisalt and 1 m LiPF₆ electrolyte. But the absence of LiF in bisalt electrolyte shows the different CEI formation than 1 m LiPF₆ electrolyte.

In conclusion, even though the content of LiPF₆ is a minority component in the bisalt electrolyte, the CEI in the bisalt electrolyte mainly contains LiₓPO_{y}F and LiₓPO_{y}F instead of LiF derived CEI in 1 m LiPF₆ electrolyte and CF₂ dominated CEI in 3.5 m LiBETI electrolyte.

In addition to studying the CEI information at different cycles, we also measured the XPS of NCM811 cathodes at 100 cycles with different etching times. As shown in FIG. 7F, FIG. 7G, FIG. 7H and FIG. 7I, showing the XPS of spectra C1s, O1s, F1s, P2p, respectively, as the etching time increases from 0 s to 120 s, the CEI information will be exposed from surface to near surface. In this way, we can reveal the CEI changes as the cycle processes. The C1s, O1s, F1s, P2p spectra of the cycled NCM811 in 2 m LiBETI+0.5 m LiPF₆ remain the same, which indicates the stable CEI during long term cycles. In contrast, the C1s, O1s, F1s, P2p spectra of the cycled NCM811 in 1 m LiPF₆ show obvious changes, indicating the unstable CEI and continuous electrolyte consumption.

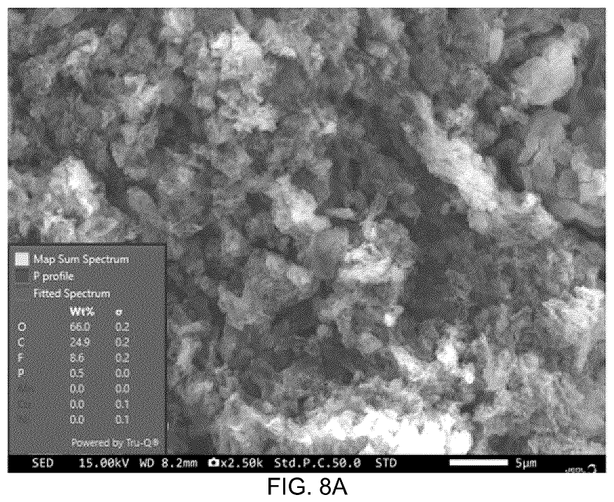

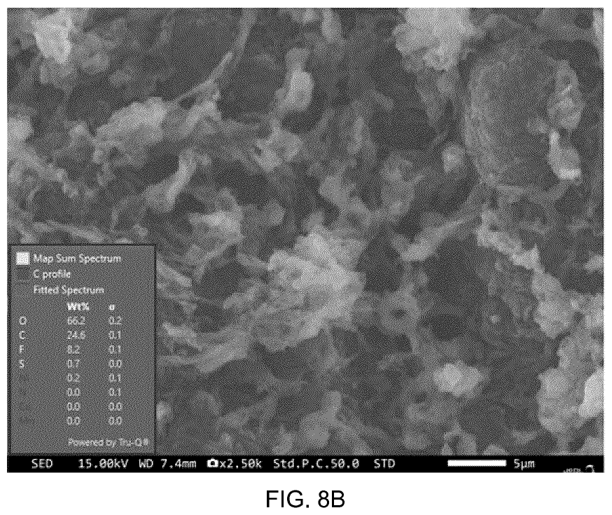

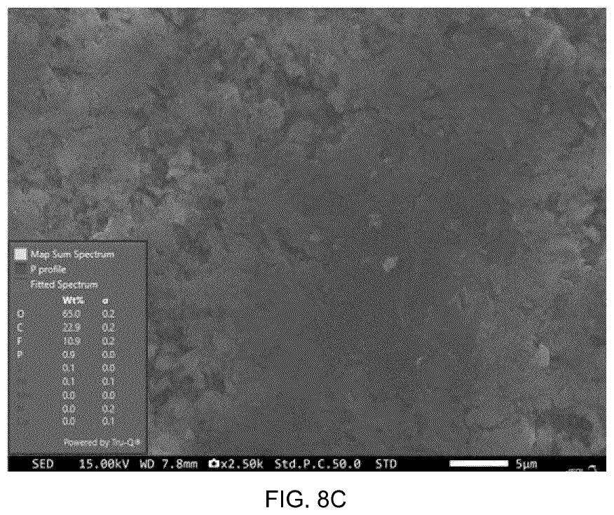

The change in lithium anode morphology was examined by the SEM technique. FIG. 8A, FIG. 8B and FIG. 8C are scanning electron microscope (SEM) images of the morphology of lithium anodes after 100 cycles in NCM811/Li half cells. Uniform lithium plating is achieved in the bisalt electrolyte in the NCM811/Li half-cell after 100 cycles. In comparison, a porous lithium anode structure is observed in 1 m LiPF₆ and 2 m LiBETI.

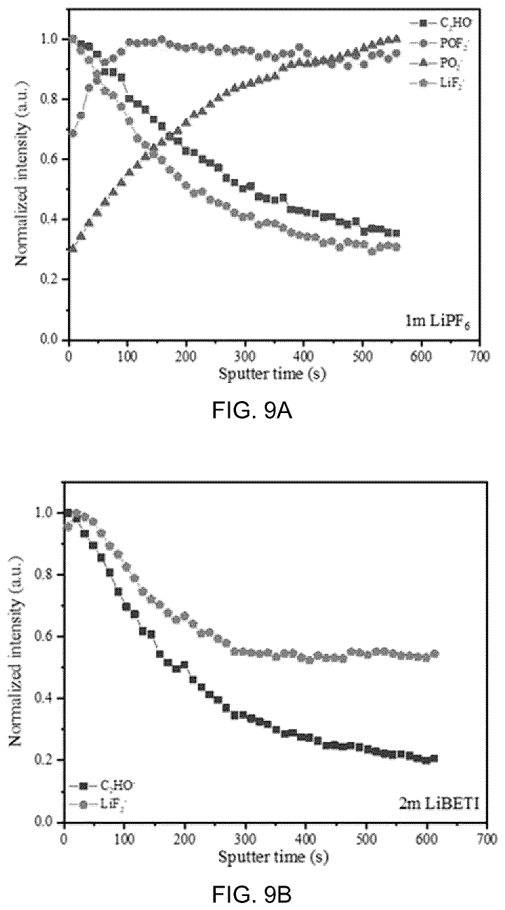

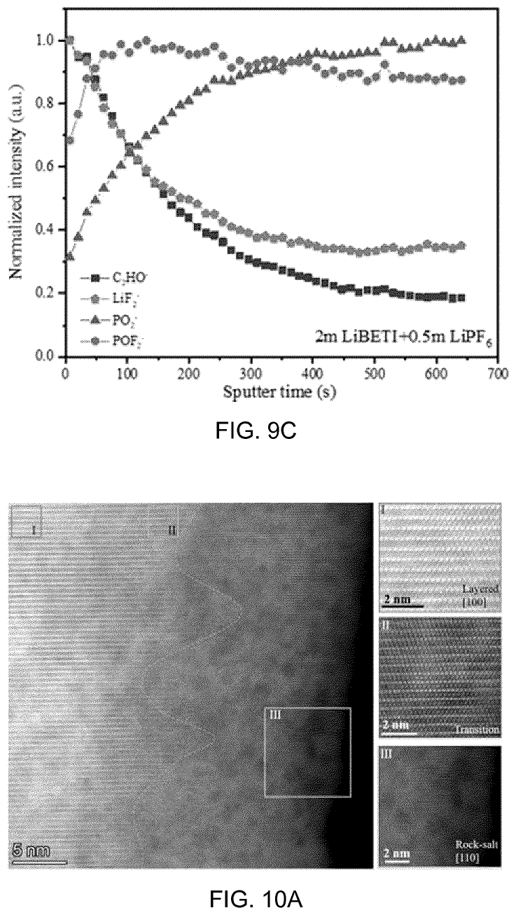

During repeated charge/discharge cycles, continuous side reactions between the electrolyte and electrodes, including parasitic electrolyte oxidation and transition-metal dissolution, lead to irreversible capacity fading. These reactions also cause fractures that allow deeper electrolyte infiltration, accelerating bulk degradation. FIG. 9A, FIG. 9B and FIG. 9C show depth profiles of the Time-of-Flight Secondary Ion Mass Spectrometry (ToF-SIMS) of NCM811 cathodes in different electrolytes after 100 cycles. ToF-SIMS is an effective method to disclose the species on the surface and near surface of the cycled electrode. As shown is these figures, the C₂HO— and PO₂— species were generated by the side reactions among the PF₆—, the nucleophilic oxygen atoms, and the alkyl carbonate after decomposition of carbonate solvents, respectively. As the sputter time increases from 0 s to 600 s, the intensity of C₂HO— and LiF₂— dresses, indicating the fewer C₂HO— and LiF₂— species near the electrode.

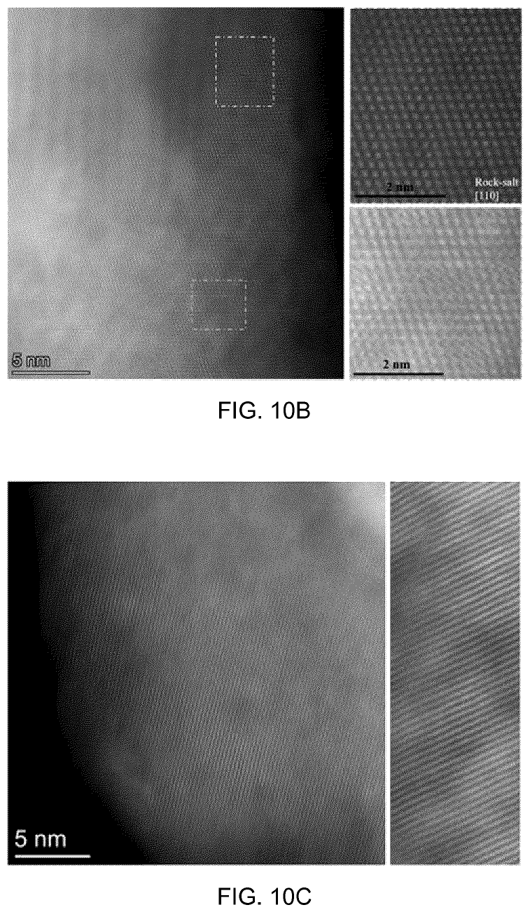

The atomic structure of NCM811 after cycling was studied by HR STEM. FIG. 10A, FIG. 10B, and FIG. 10C are HR STEM images of NCM811 particles after 100 cycles in an operation voltage of 2.8-4.6 V: in 1 m LiPF₆, in 2 m LiBETI, in 2 m LiBETI+1 m LiPF₆, respectively. The layer structure of the NCM811 cathode is preserved in the bisalt electrolyte. However, the clear phase transition from layer to rock-salt to spinel phase is shown in 1 m LiPF₆, and in 2 m LiBETI electrolyte. This further demonstrates the protection ability of CEI on the NCM811 cathode in the bisalt electrolyte.

In addition to acting on the surface, the CEI formed in the bisalt electrolyte contributes to restrain mechanical degradation of NCM811 secondary particles. Intergranular cracking between connected primary particles is a critical issue for the degradation of high-voltage Ni-rich cathodes, leading to the loss of electrical contact between primary particles. The resultant high surface area means more liquid electrolytes required for wetting, severe side reactions, and massive electrolyte consumption. The intergranular cracking was further inspected using SEM on the cross-sectioned NCM811 cathodes after 100 cycles. In contrast to the presence of apparent cracks between the primary particles in the 1 m LiPF₆ and the 2 m LiBETI electrolytes, the mechanistic integrity of NCM811 cathode is well maintained in the bisalt electrolyte, which suppresses surface side reactions and benefits the Coulombic efficiency.

What is claimed is:

1. A composition for preparing a lithium battery electrolyte, comprising lithium bis(pentafluoroethanesulfonyl)imide (LiBETI) and lithium hexafluorophosphate (LiPF₆).

2. The composition of claim 1, comprising LiBETI and LiPF₆ is a molar ratio of 6:1 to 1:3, more preferably 3:1 to 1:1, most preferably 2:1.

3. An electrolyte for a lithium battery, comprising:
lithium bis(pentafluoroethanesulfonyl)imide (LiBETI),
lithium hexafluorophosphate (LiPF₆), and
and an organic solvent.

4. The electrolyte of claim 1, wherein the organic solvent comprises fluoroethylene carbonate (FEC).

5. The electrolyte of claim 4, wherein the organic solvent further comprises:
ethylene carbonate (EC), and
ethyl methyl carbonate (EMC).

6. The electrolyte of claim 3, wherein the LiBETI and LiPF₆ are preset in a molar ratio of 6:1 to 1:3, more preferably 3:1 to 1:1, most preferably 2:1.

7. The electrolyte of claim 3, wherein the LiBETI has a concentration of at least 0.5 m, more preferably at least 1 m, and most preferably at least 1.5 m.

8. The electrolyte of claim 3, wherein the LiPF₆ has a concentration of at least 0.25 m, more preferably at least 0.5 m, and most preferably at least 0.75 m.

9. The electrolyte of claim 5, wherein the LiBETI has a concentration of at least 1 m, and the LiPF₆ has a concentration of at least 0.5 m.

10. The electrolyte of claim 9, wherein the LiBETI has a concentration of at least 1.5 m, and the LiPF₆ has a concentration of at least 0.75 m.

11. A lithium battery, comprising:
an anode comprising lithium,
a cathode comprising nickel,
and an electrolyte containing:
lithium bis(pentafluoroethanesulfonyl)imide (LiBETI),
lithium hexafluorophosphate (LiPF₆), and
an organic solvent.

12. The lithium battery of claim 11, wherein the cathode comprises LiNi_{0.8}Co_{0.1}Mn_{0.1}O₂ (NCM811).

13. The lithium battery of claim 12, wherein the organic solvent comprises fluoroethylene carbonate (FEC).

14. The lithium battery of claim 13, wherein the organic solvent further comprises:
ethylene carbonate (EC), and ethyl methyl carbonate (EMC).

15. The lithium battery of claim 12, wherein the LiBETI and LiPF₆ are preset in a molar ratio of 6:1 to 1:3, more preferably 3:1 to 1:1, most preferably 2:1.

16. The lithium battery of claim 12, wherein the LiBETI has a concentration of at least 0.5 m, more preferably at least 1 m, and most preferably at least 1.5 m.

17. The lithium battery of claim 12, wherein the LiBETI has a concentration of at least 1 m, and the LiPF₆ has a concentration of at least 0.5 m.

18. The lithium battery of claim 14, wherein the LiBETI has a concentration of at least 1.5 m, and the LiPF₆ has a concentration of at least 0.75 m.

19. The lithium battery of claim 18, wherein the LiBETI has a concentration of at least 2 m, and the LiPF₆ has a concentration of at least 1 m.

20. An electronic device, comprising the lithium battery of claim 11.
